(19) United States
(12) Patent Application Publication
(10) Pub. No.: US 2013/0145737 A1
(43) Pub. Date: Jun. 13, 2013

(54) Liquid delivery device for attaching to a walk-behind lawn mower or other similar machine

(71) Applicant: Thomas Parham, Oregon City, OR (US)

(72) Inventor: Thomas Parham, Oregon City, OR (US)

(21) Appl. No.: 13/324,055

(22) Filed: Dec. 13, 2011

(51) Int. Cl. A01D 34/00

(52) U.S. Cl. 56/16.8

(57) ABSTRACT

In one contemplated embodiment, the present invention is a liquid delivery device for attaching to a walk-behind lawn mower or other similar machine. The device includes at least one means for attaching the device to the machine, and preferably a pair of straps for releasably attaching the tank assembly to the handle-portion of the lawn mower. The device includes the tank body assembly having at least one vertical sidewall coupled to a closed bottom at an end opposite an open top to define an interior volume. A cap selectively seals the open top and includes a pressurizing assembly. A wand assembly is operationally coupled to the fluid storage tank assembly, the wand assembly includes a hose operationally coupled to the interior volume of the tank assembly.

### BACKGROUND

The present invention relates to a device that attaches to a walk-behind garden machine, such as a lawnmower, and selectively dispenses a liquid such as an herbicide. The invention is particularly suited for lawn maintenance whereby a a lawn mower, or other similar walk-behind implement, is used to maintain a lawn, and in performing maintenance there is a need to spot deliver a small dose of an herbicide.

Walk behind lawn implements are commonly used in lawn and grounds maintenance and such implements include push lawn mowers including gas powered, electric powered and inertia powered lawn mowers, other implements include wheelbarrows, leaf blowers, weed trimmers, and the like. In addition, the use spot-dispensing liquids such as herbicides, fungicides, and insecticides are also commonly employed in lawn and grounds maintenance. Typically, a hand-held bottle or back-mounted tank are used with a hand-pump to pressurize the container and spray the liquid on a particular problem spot.

One improvement to the hand-held or back-mounted herbicide container is the combination blower and herbicide-spraying device taught by Loaces in U.S. Pat. No. 7,766,256 issued on 03 Aug. 2010. Loaces teaches a grounds maintenance device and a fluid spraying device including a container mounted on the ground maintenance device and a spraying member that is moveable from a carrying position to a spraying position. One limitation of the device of Loaces is that the operation of the spraying device in the spraying position requires that the operator stop his or her primary use of the grounds maintenance device (i.e. stop leaf blowing), disengage the spray handle from the grounds device (which requires the operator balance the grounds device in one hand), and aim the spray handle at the target area, and then squeeze the trigger to dispense the liquid. This technique is hazardous to the operator and others as the grounds maintenance device is designed to operate with two hands, and removing one hand can result in the grounds device to become unbalanced, which in turn, may cause the operator to fall down, or to inadvertently aim the device toward other people or property. Further, the act of stopping the primary operation of the grounds device to operate the spray device is inefficient and results in lost productivity of the operator.

Overcoming the loss of efficiency and danger in operation of the Loaces device, Labar et al., in U.S. Pat. No. 7,681,385 issued on Mar. 23, 2010 teaches a mower liquid herbicide applicator. Therein Labar et al. teach an apparatus and method for supply of treating fluid to a cutting apparatus directly to cut vegetation substantially simultaneously with the cutting of the vegetation. Treating fluid is delivered from the supply to an intermediate, sealed reservoir into which a desired volume of treating fluid is maintained. The treating fluid is then delivered from the sealed reservoir, via centrifugal force, through a channel to a passageway formed in the bolt connecting the cutting blade to a blade mount of the mower. The treating fluid is ejected from the bolt passage directly onto the exposed undersurface of the cutting blade and directly to the vegetation at the same time that it is cut so that the treatment fluid, herbicide or other chemical is absorbed directly into the translocation system of the cut vegetation. One limitation of the Labar et al. device is that it is designed for large-scale lawn mowers that are pulled behind a tractor and as such require a complex delivery system and, moreover, cannot adequately adapt for a walk-behind mower use and cannot reliably be used for “spot” spraying a small area. Labar et al. teach away from the small spot application and rather teach a large-area distribution of a consistent amount of liquid to be applied simultaneously with the cutting operation of the mower.

Overcoming some of the limitations of the Labar et al. device, Jacobson in U.S. Pat. No. 6,908,052 teaches a lawn mower sprayer assembly in U.S. Pat. No. 6,908,052 issued on Jun. 21, 2005. Therein, Jacobson describes a pressurizing assembly that is operationally coupled to a container member. The fluid storage tank is designed for storing a fluid in a pressurized state when the pressurizing assembly is actuated by a user. A delivery assembly is operationally coupled to the fluid storage tank and is designed for receiving the fluid under pressure and distributing the fluid onto the lawn. Jacobson teaches a rather large tank for storing a liquid and at least one nozzle, and preferably a pair of nozzles for distributing the fluid under pressure. However, the tank is large enough to cause the mower to tip over when full and further cannot adapt to spot spray and further is overly complex and requires precise location of tab member relative to cross members on the lawnmower, teaching away from retrofitting existing lawnmowers.

Larger-scale fluid distribution devices adapted to work with ride-on implements (such as garden lawn tractors and small farm tractors) are generally known in the art. Examples of such devices include the lawn mower fluid dispenser of Dunlap in U.S. Pat. No. 6,808,126 issued on Oct. 26, 2004. Dunlap teaches a riding lawn mower having a large fluid tank with an on/off valve sending fluid to dispensing nozzles on the deck of the lawn mower. One limitation of Dunlap's device is that the on/off valve allows only continuous dispersal of the fluid and teaches away from spot treatment, and the volume of liquid taught by Dunlap teaches away from carrying this amount on a push-behind implement. Other similar systems include, for example, the teaching of Grote et al. in U.S. Pat. No. 5,195,308 issued on Mar. 23, 1993. Grote et al. teaches a mower having fluid dispersion characteristics that uses an electric power source to run solenoid triggered valves and pumping mechanisms to disburse a large-quantity of fluid to the deck area of a lawn mower. In one embodiment, Grote discusses a wand for spot-treatment, yet couples the wand to the complex large-scale storage and electrically controlled disbursement system.

In fact, the art is replete with large-scale fluid dispersing nozzles mounted relative to a lawn-mower deck. Examples in the art include Holley, in U.S. Pat. No. 6,497,088 issued on Dec. 24, 2002, which teaches a rotary mower with liquid applicator including nozzles mounted in proximity of cutting blades on the deck of a mower and Burch, in U.S. Pat. No. 6,374,586 issued on May 23, 2002, which augments the teaching of Holley by including a computerized controller to disburse the fluid while cutting. In yet another example, McKee, in U.S. Pat. No. 4,926,622 issued on May 22, 1990, teaches a combined rotary cutter and herbicide applicator and method. And Vicendese et al., in U.S. Pat. No. 3,942,308 issued Mar. 9, 1976, teaches a chemical dispensing lawn mower arrangement. In each of these foregoing examples, a common limitation includes the use of a large-scale ride-on tractor, a large reservoir and continuous feed of the dispensing nozzles. Generally, the art teaches away from a small-scale, spot treatment while walking behind a push-style lawnmower. Indeed there is no instruction in the aforementioned references as how to modify their systems to work with a push-mower without causing the mower to tip over due to the weight of the liquid storage tank, to modify existing machines to carry a distribution system, and no contemplation of spot-treating while walking.

Also known in the art, stand-alone, walk behind, fluid-dispensing devices include the portable self-energizing pressure sprayer of Leer et al. taught in U.S. Pat. No. 6,565,015 issued on May 20, 2003, and U.S. Pat. No. 4,508,248 issued on Apr. 2, 1985 to Ridgeon. These references teach a push unit dedicated to continuously dispensing fluid as the user walks behind the machine. No cutting operation is possible with the devices of Ridgeon and Leer.

Thus, there remains a need for a fluid delivery system that adapts to fit on both walk-behind and ride-on lawn and grounds devices and can be adapted for use on existing (retrofitting) lawn and grounds implements. Such a device should not continuously dispense a fluid, but rather enable an operator to spot spray a concentrated amount of fluid on a specific spot while simultaneously walking behind a push lawn implement, such as a lawn mower, and enable the simultaneous operation of both the primary function (i.e. cutting the lawn) with the secondary function (i.e. spot treating with an herbicide). Moreover, there is a need for such a device to be retrofitted on existing push implements by common do-it-yourself lawn owners without the cost or complexity taught in the known art.

### SUMMARY OF THE INVENTION

To overcome the known limitations of the teachings in the art, and to provide a more simple, more reliable, lest costly, and easier to use system that enables an operator of a push-style lawn implement to deliver an as-needed, spot-spraying amount of a fluid, the present invention contemplates a compact fluid delivery system that can easily be retrofitted to existing lawn mowers and similar push devices. Alternatively, the present invention can be designed into a newly manufactured push mower and the like.

Certain advantages of the present invention include the ability to retrofit the device to existing push-style lawn implements, regardless of design or purpose. Further, the present invention provides a more robust pressurizing system over the teachings of the current art and a smaller tank design that is less likely to cause the push-style lawn implement to tip over due to the weight of the fluid in the tank. Also the present invention includes a wand for spot spraying the fluid in a targeted manner not taught or contemplated in the known art.

Some advantages of the present invention include the ability to spot spray weeds as, for example, the lawn is mowed. This is an advantage because the present invention enables spaying as needed. In contrast, with conventional weed sprayers, you have to go back and try to find weeds that have already been mowed making it virtually impossible to find. The present invention is convenient because it is attached to the lawn mower, and removable. The user can also care for your flowers beds, and spot spray all area of a property. The weight of the sprayer is attached to the mower, so that the user doesn't have to pack heavy bulky spray units. However, it is light enough that it does not compromise the stability of the lawn mower or make it too heavy to push. It is universal for different chemicals, so that the user can choose the type of chemical/ liquid for spraying.

### DRAWING

FIG. 1 is a side view of a liquid delivery device according to one preferred embodiment of the present invention.

FIG. 2 illustrates the device of FIG. 1 attached to a known push-style lawn implement—i.e. a lawnmower.

FIG. 3 is a cross sectional view of the embodiment of FIG. 1.

### DESCRIPTION OF THE INVENTION

Possible preferred embodiments will now be described with reference to the drawings and those skilled in the art will understand that alternative configurations and combinations of components may be substituted without subtracting from the invention. Also, in some figures certain components are omitted to more clearly illustrate the invention.

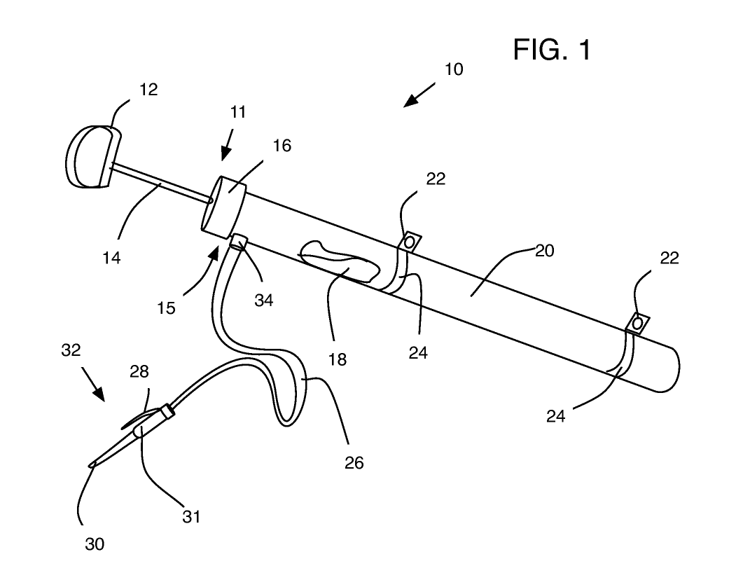

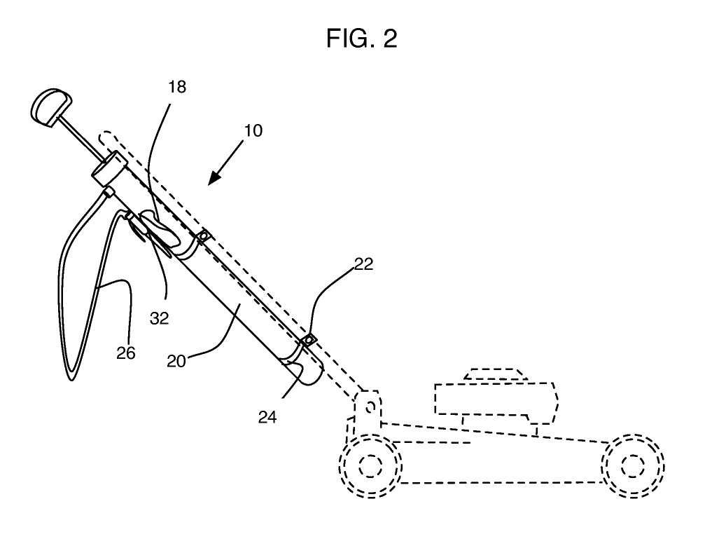

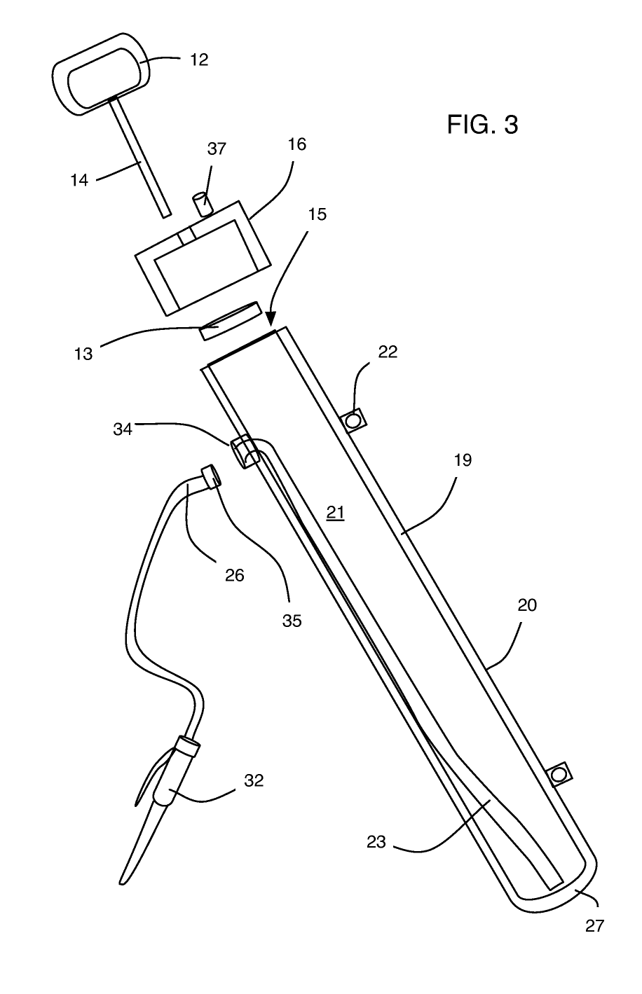

Making general reference to FIGS. 1-3, a liquid delivery device 10 for attaching to a lawn apparatus such as a walk-behind lawn mower or other similar machine includes at least one, a preferably at least two means for attaching the device to the push-type garden machine. One contemplated means for attaching the device includes a pair of straps 24 and eyelets 22 that arrange on the device 10 and slideably position to correspond to enable the strap to wrap around the device and a support structure provided by the push-machine, as those skilled in the art can appreciate from, for example, FIG. 2.

The device 10 includes a tank body assembly 20, which includes at least one vertical sidewall 19 and a closed bottom 27 at an end opposite an open top 15. In a preferred embodiment, the tank body is an elongated cylinder, however other cross-sections would work as well including ovoid, hexagonal, or rectangular shapes, for example. The open top receives a cap 16. Because the tank volume 21 defined by the bottom 27, sidewall 19, and cap 16 will be pressurized, known means for sealing the cap to the open top 15 are contemplated. Further, because the open top 15 needs to be periodically accessed to fill the volume 21 with a desired fluid, the cap 16 should releasably couple to the open top 15: Accordingly, the open top and cap have cooperating, mating threads and a sealing member, such as an annular grommet, or gasket, or o-ring (not depicted in the drawing), as would be generally understood in this art.

The cap 16 further includes a pressurizing assembly 11, which is operationally coupled to the fluid storage tank 20. The pressurizing assembly pressurizes the fluid storage tank from a nominal state relatively close to the overall atmospheric pressure of the environment to a positively pressurized state when the pressurizing assembly is actuated by a user. Alternatively, the pressurizing assembly can be adapted to operate at ambient pressure or positive or negatively pressures, as would be required for various fluids as would be well understood by those in the art. A one way valve 37 mounted to the cap 16 to enable one-directional flow of out of the tank is in fluid communication with the tank, as would be appreciated by those skilled in this art.

A wand assembly 32 is operationally coupled to the fluid storage tank assembly 20 whereby the wand assembly 32 is in fluid communication with the fluid in the fluid storage tank assembly 20. The wand assembly 32 receives the fluid under pressure and, through user interaction, is spot sprayed on a particular spot on the lawn.

A holster device 18 arranges on an exterior portion of the tank assembly and is adapted to selectively and releasably hold the wand assembly 32 whereby the wand assembly may be detached from the tank by a user and directed to spot spray a weed or portion of the lawn by the user. The wand assembly, accordingly, has a flexible hose member with one nozzle at the end of the hose for directional and selective dispersal of the fluid stored in the tank.

The fluid storage tank assembly 20 comprises at least one sidewall 19 and closed bottom wall 27. The at least one sidewall 19 defines an interior volume 21 of the fluid storage tank assembly 20. The interior volume 21 of the tank assembly 20 is designed for receiving the fluid whereby the fluid storage tank assembly 20 stores the fluid received by the interior volume 21 of the tank assembly 20. The pressurizing assembly 11 is coupled to the at least one sidewall 19 of the tank assembly 20 whereby the pressurizing assembly 11 is in fluid communication with the interior space of the tank assembly 20. The pressurizing assembly 11 is for pressurizing the interior volume 21 of the tank assembly 20.

The at least one sidewall 19 of the tank assembly 20 comprises an open top 15 at one end of the tank and a closed bottom wall at an opposite end to define an interior volume 21. In a preferred embodiment, the interior volume defined by the tank assembly is an elongated cylinder, although other shapes for the tank assembly may also be used. The open top 15 extends through the at least one sidewall 19 of the tank assembly 20 whereby the open top 15 couples to the pressurizing assembly 11. The open top 15 of the tank assembly 20 is designed for permitting the fluid to be poured into the interior volume 21 of the tank assembly 20 through the open top 15. The pressurizing assembly 11 is selectively coupled to the at least one sidewall 19 whereby the pressurizing assembly 11 is selectively positioned in the open top 15 of the tank assembly 20 to inhibit the fluid from being inadvertently spilled from the interior 20 space 20 of the tank assembly 20.

The at least one sidewall 19 of the tank assembly 20 includes a fitting 34. The fitting 34 extends through the at least one sidewall 19 whereby the fitting 34 is in fluid communication with the interior volume 21 of the tank assembly 20. A wand assembly 32 is coupled to the fitting 34 by means of a mating fitting 35 for a one-way direction of pressurized fluid from the tank when the wand assembly is activated to release the fluid.

An internal siphon tube 23 with an open bottom is in fluid communication with the fitting 34 on the sidewall 19 to direct pressurized fluid to the wand assembly 32 when the actuator 28 is depressed by the user. The wand assembly 32 is well understood by those in the art and additional components and their operation is not fully detailed herein.

The pressurizing assembly 11 includes a pressurizing handle 12, connecting rod 14, internal piston 13 and cap 16. The pressurizing handle 12 is operationally coupled to a cap 16, which in turn couples to the open top 15 of the tank assembly 20 (i.e. the cap screws on top of the tank assembly at the open top 15 to create an air-tight seal therewith). The pressurized handle 12 connects to a piston connecting rod 14 that is operable through the cap 16 and connects the handle to a piston or diaphragm 13 (cooperating with a one way valve 37) the pressurizing assembly 11. The pressurizing handle 12 is for actuating the pressurizing assembly 11 whereby the pressurizing assembly 11 pumps air into the interior volume 21 of the tank assembly 20 to pressurize the tank assembly 20 when actuated by the user.

The wand assembly 32 comprises at least one nozzle 30. The nozzle 30 is operationally coupled to the tank assembly 20 whereby the nozzle 30 is in fluid communication with the interior volume 21 of the tank assembly 20. The nozzle 30 is designed for spraying the fluid from the tank assembly 20 onto the lawn when the tank assembly 20 is pressurized by the pressurizing assembly 11.

The wand assembly 32 includes a hose member 26. The hose member 26 is operationally coupled between the nozzle 30 and the tank assembly 20. The hose member 26 is in fluid communication with the interior volume 21 of the tank assembly 20 and the nozzle 30 of the wand assembly 32 whereby the hose member 26 is designed for conducting the pressurized fluid from the interior volume 21 of the tank assembly 20 to the nozzle 30 of the wand 32.

The wand assembly 32 comprises a flow control member 42, such as a dial at the end of the wand. Such flow-control members are well understood in the art and therefore, are not detailed in the drawings. The flow control member 42 is operationally coupled between the nozzle 30 and the tank assembly 20 whereby the flow control member 42 is in fluid communication between the tank assembly 20 and the nozzle 30. The flow control member 42 is designed for controlling the flow of pressurized fluid from the tank assembly 20 to the nozzle 30 when the user actuates the flow control member 42.

In use, the user preselects a fluid, such as an herbicide or liquid fertilizer, or the like. This fluid, which will be spot-sprayed by the user at a desired location) is poured into the interior volume 21 of the tank assembly 20 through the open top 15. The cap 16, which includes the pressurizing assembly 11, is then screwed over the open top creating a sealed volume 21.

The pressurizing handle 12 is then gripped by the user and actuated with respect to the pressurizing assembly 11 to actuate the pressurizing assembly 11 to pump air from the environment into the interior volume 21 of the tank assembly 20 to pressurize the fluid in the interior volume 21 of the tank assembly 20. The user then actuates the control member 42 and the fluid is transferred from the interior volume 21 of the tank assembly 20 through the hose member 26 to the nozzle 30 to be sprayed on the lawn as the user mows the lawn. The control member may be actuated again to discontinue flow from the tank assembly 20 to the nozzle 30. The pressurizing handle 12 may have to actuated while the user is in the process of the mowing the lawn to pressurize the tank assembly 20 as the tank assembly 20 is depressurized when the fluid is sprayed from the nozzle 30.

The liquid delivery device 10 includes a pressurizing assembly 11 coupled to the tank assembly 20. And, the tank is necessary to cooperate with the pressurizing assembly to pressurize the contained fluid. As such the tank assembly 20 can be made of metal but is preferably made of plastic for light weight reasons and for improved compatibility with the chemical solutions to be dispensed from the wand 32. As previously described, the tank assembly 20 includes an open top 15. The open top is adapted to support a cap 16 and pump including handle 12, connecting rod, and piston diaphragm 13. The pressurizing assembly 11 is essentially hand pump that can be used to pressurize tank 20 to force the liquid solution from the tank. An internal conduit 23 (or siphon tube) extends from a bottom portion of the tank and is in fluid communication with fitting 34 that extends through the at least one sidewall 19 and is used to convey the liquid material up and out of the tank into a flexible hose 26. Hose 26 is attached to a wand assembly 32 and has a fitting 35 connected to the hose. A hand operated actuator 28 user-selectively controls the flow of liquid through into the wand's tubular member 31 and on to nozzle 30, which is supported on the end of dispensing tube 31. Nozzle 30 includes an adjusting mechanism to vary the pattern and volume of fluid, as would be understood by those skilled in this art.

In operating the lawn and garden sprayer the chemical solution can be mixed outside or inside tank 11. The components can be poured in through opening 13. After the tank is filled with the proper amount of liquid material, hand pump/closure member 15 is used to close input 13. The hand pump can then be operated several times to pressurize tank 11. When operating handle 27 is compressed toward valve 25, the liquid in tank 11 will flow into tube 17 and then into flexible hose 21 through fitting 19. Valve 25 controls the flow of fluid into dispensing tube 29 and on to adjustable nozzle 31. Nozzle 31 can be adjusted to provide a single stream or varying size spray patterns.

Although the invention has been particularly shown and described with reference to certain embodiments, it will be understood by those skilled in the art that various changes in form and detail may be made without departing from the spirit and scope of the invention.

I claim:

1. A liquid delivery device for attaching to a walk-behind lawn apparatus, the liquid delivery device comprising:
at least one means for attaching the device to the apparatus, the means comprising at least one strap having a corresponding eyelet;
a tank body assembly supported by the means for attaching the device to the apparatus, the tank body assembly comprising at least one vertical sidewall coupled to a closed bottom at an end opposite an open top to define an interior volume, and a holster device coupled to an exterior portion of the tank body;
a cap selectively coupling to the open top, the cap comprising sealing means and a pressurizing assembly; and
a wand assembly operationally coupled to the fluid storage tank assembly, the wand assembly comprising a hose operationally coupled to the interior volume of the tank assembly, the wand assembly further including one nozzle disposed on an end of the hose, the wand assembly further being selectively releasably carried by the holster device on the tank.

2. The means for attaching the device of claim 1 further comprising:
a second strap.

3. The device of claim 1 further comprising:
a flow control member operationally coupled between the nozzle and the tank assembly and in fluid communication with the interior volume.

4. A liquid delivery device for attaching to a walk-behind lawn mower for spot spraying a liquid onto a lawn, the lawn mower including a handle assembly including a pair of arms extending rearwardly and upwardly from a deck, and at least one cross member extending between the arms, the liquid delivery device comprising:
a first strap member for coupling the device to one arm of the lawn mower at a position above the cross member and a second strap for coupling the device to the same arm of the lawn mower at a position below the cross member;
a tank body assembly supported by first and second strap members, the tank body assembly comprising one vertical sidewall coupled to a closed bottom sidewall having an ovoid shape at an end opposite an open top to define an interior volume having a cylindrical shape, and the tank body further comprising a holster device coupled to an exterior portion of the tank body;
a cap selectively coupling to the open top, the cap comprising sealing means and a pressurizing assembly; and
a wand assembly operationally coupled to the fluid storage tank assembly, the wand assembly consisting of a flexible hose operationally coupled to the interior volume of the tank assembly, one nozzle disposed on an end of the hose, and a flow control member operationally coupled between the nozzle and the tank assembly and in fluid communication with the interior volume, and wherein the wand assembly further being selectively releasably carried by the holster device on the tank.
